(19) United States
(12) Patent Application Publication
(10) Pub. No.: US 2003/0094289 A1
(43) Pub. Date: May 22, 2003

(54) Device and method for forcing flower bulbs

(76) Inventors: Etwalt Groot, Enkhuizen (NL); Andre Aldert Balk, Enkhuizen (NL); Jan De Vries, Gs Bovenkarspel (NL)

Correspondence Address: Westman Champlin & Kelly, International Centre Suite 1600, 900 Second Avenue South, Minneapolis, MN, 55402-3319, US

(21) Appl. No.: 10/203,598

(22) PCT Filed: Feb. 12, 2001
(86) PCT No.: PCT/NL01/00119

(30) Foreign Application Priority Data
Feb. 10, 2000 (EP) 1014343

(51) Int. Cl. A01D 13/00

(52) U.S. Cl. 171/1

(57) ABSTRACT

The invention relates to a device (1) for forcing flower bulbs (11), which device (1) comprises at least one plate (4) or plate-like body provided with one or more holes (6), into which a flower bulb (11) can be placed. The edge (10) of at least one of the holes (6), but preferably of all holes (6) is elastic and/or flexible to such an extent that a flower bulb (11) can be clampingly received in said hole (6). Preferably, at least part of the edge (10) of at least some of the holes (6) formed by a flexible insert member, which preferably includes a number of flexible elements, such as teeth or fingers (15), which extend in radial direction, seen in top view.

The invention relates to a device for forcing flower bulbs, which device comprises at least one plate or plate-like body provided with one or more holes, into which a flower bulb can be placed.

In the production of flowers, flower bulbs are generally set and cultivated on the land. After the growing period, the flower bulbs are collected, peeled and graded according to size, after which they are stored. During quiet periods the bulbs are usually pre-planted, that is, planted in rows and columns in boxes containing compost. Such boxes are then placed in a cold room, from where they can be transferred to a greenhouse at any desired moment, where the forcing of the flowers takes place. After said forcing period the flowers that are ready are removed, bulbs and all, from the boxes. Then the bulb is cut loose and the flowers are bunched. Generally, it takes about eight to twelve weeks before all the flowers in a box are ready.

In order to make the production process more efficient and cheaper, so-called tank-farming has been used for a number of years. This method uses plates which are provided with, for example, pins or sticks on which the flower bulbs are stuck, or with holes, into which the flower bulbs are placed. After the flower bulbs have been placed onto or into a plate, the roots of the flower bulbs are placed in water.

The above-described current embodiments of tank-farming have a number of drawbacks. For example, by employing pins or sticks the bulb is perforated and becomes susceptible to fungi and disease. Storage in a cold room is no longer possible in that case, which in practice is a major drawback. For, after the bulbs have been stuck on a pin, they must directly be placed in water, which means that the forcing of the bulbs must take place within a fortnight from that point in time. The consequence of this is that the traditional division of labour as commonly used in forcing on compost has now changed, because pre-planting of the bulbs is no longer possible. With regard to the forcing of e.g. tulips, this means that it is no longer possible to use the period between September and December, during which there is usually less work to do in this field, for the so-called pre-planting by the permanent staff. Furthermore, it is no longer possible to pre-plant the main part of the bulbs during the autumn half-term holiday with the assistance of schoolboys and girls.

The variant involving a polystyrene foam plate provided with holes or cavities for receiving flower bulbs also incorporates a number of drawbacks, such as the development and accumulation of fungi and germs in the interstitial cavities between the polystyrene foam balls. Furthermore, it is difficult to guarantee the position of the flower bulbs over a prolonged period of time. The flower bulbs will for example expand or shrink during the growth of the flowers, causing the bulb to be displaced and the flower to be positioned at an angle, as a result of which the flower will grow askew. In addition to that, the polystyrene plates are in principle suitable for only one bulb size, so that a separate type of plate is required for every size.

The object of the present invention is to provide an improved device for forcing flower bulbs of the kind described in the introduction.

In order to accomplish that objective, the device according to the invention is characterised in that the edge of at least one of the holes, but preferably of all holes, is elastic and/or flexible to such an extent that a flower bulb can be clampingly received therein.

Thus, the flower bulbs can be planted in an efficient manner without being damaged and without restricting the growth possibilities of the roots or the flower.

Preferably, the edge comprises a number of flexible elements, such as teeth or fingers, which, seen in top view, extend in radial direction, so that a very effective adaptation of the shape of the clamping edge to that of the bulb is obtained. Moreover, the flexible elements will adapt to the shape of the bulb, also after the planting, when said bulb expands or shrinks during the growth of the bulb. In other words, the flexible elements follow the bulb during expansion or shrinking thereof, as a result of which the position of the bulb remains ensured.

In order to simplify inter alia the manufacture and the maintenance of the device according to the invention, it is preferred that at least part of the edge of at least some of the holes in the plate or plate-like body is formed by a flexible insert member. In that case said body can for example be made of a usual plate material, after which the aforesaid insert pieces are inserted into one or more of the holes. It is preferred that the edge of said insert member comprises a number of the said flexible elements.

The aforesaid holes are preferably circular in shape. Furthermore, they preferably have an effective diameter of more than 42 mm, since in that case the device according to the invention will in principle be suitable for flower bulbs having a size ranging between 9 and 13 or even 14. Said sizes comprise the larger part of the usual flower bulbs.

The invention furthermore relates to an insert member suitable for use in the above-described device, as well as to a method for pre-planting the flower bulbs, wherein use is made of the device as described above.

The invention will now be explained in more detail with reference to the figures, which schematically show three embodiments of the device according to the invention.

FIG. 1 is a cross-sectional view of a first forcing rack according to the invention, in which 12×18 flower bulbs have been planted.

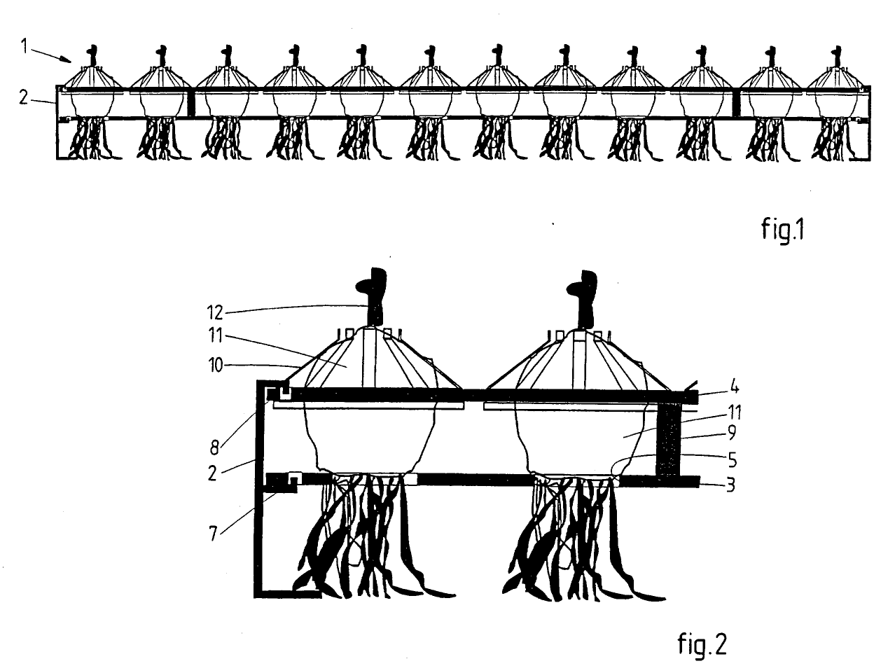

FIG. 2 shows a detail of the forcing rack according to FIG. 1.

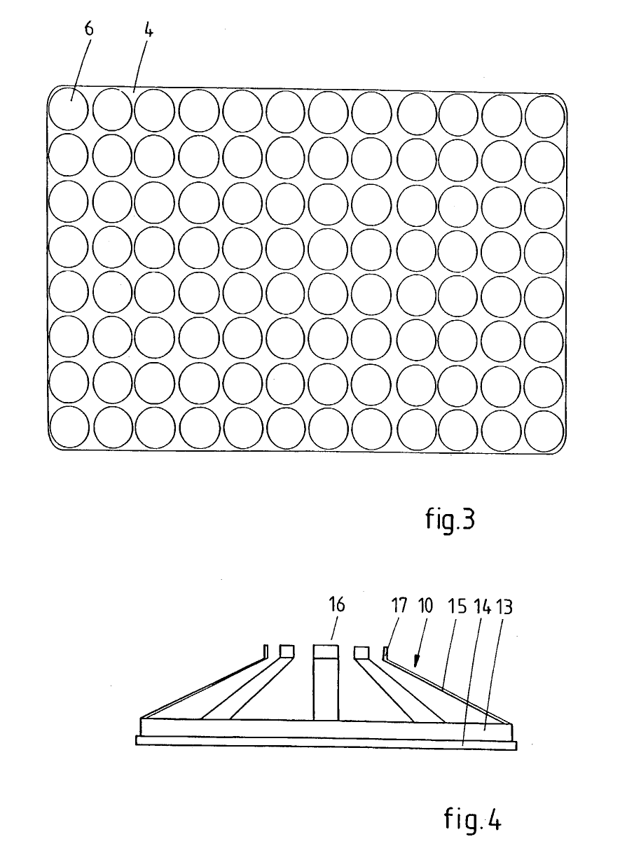

FIG. 3 is a top view of the upper plate of the forcing rack as shown in FIGS. 1 and 2.

FIG. 4 is a side view of a first insert member for use in the forcing rack according to FIGS. 1 and 2.

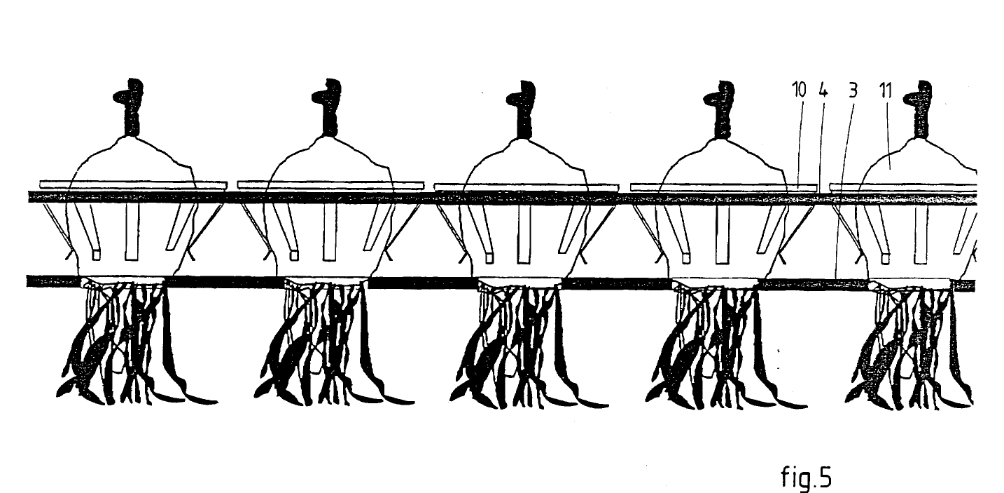

FIG. 5 is a cross-sectional view of a part of a second forcing rack according to the invention.

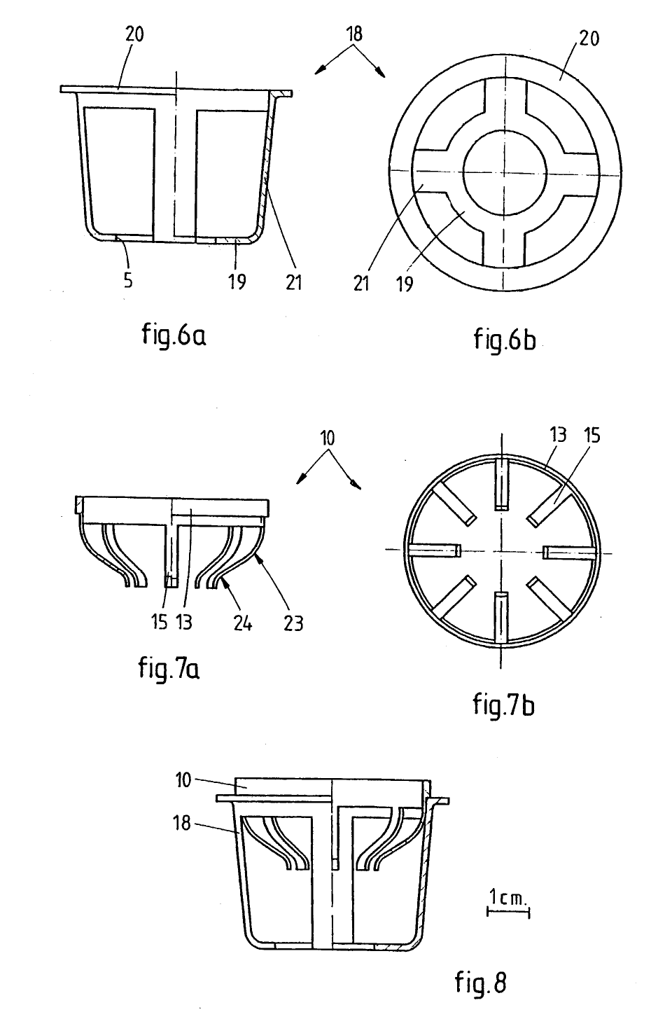

FIGS. 6A and 6B are respectively a side view (partially in cross-section) and a top view of part of a third forcing rack according to the invention.

FIGS. 7A and 7B are respectively a side view (partially in cross-section) and a top view of a second insert member for use in the forcing racks according to the invention.

FIG. 8 is a side view (partially in cross-section) of the second insert member placed in the third forcing rack.

Identical or comparable parts are consistently indicated by the same numerals in the various figures.

FIGS. 1 and 2 show a forcing rack 1 suitable for the planting, storing and forcing of for example tulip bulbs, which rack comprises a frame 2, in which a first plate or bottom plate 3 and a second plate or upper plate 4 are fixed. Both plates 3, 4 are in this specific embodiment provided with 12×8 circular holes 5 and 6, respectively (see FIG. 3). Seen in top view the centres of the relatively large holes 6 in upper plate 4 and the centres of the relatively small holes 5 in bottom plate 3 are practically in line. Plates 3, 4 can be cut from a metal, such as aluminium, or can be made from a plastic material, such as SAN, PMMA, PC, POM, PVC or a polyolefin (such as PP) or polyester, by means of an injection-moulding process. If the plates 3, 4 are opaque, the growth of algae is effectively suppressed or even prevented.

Plates 3, 4 are fixed in frame 2 by means of snap connections 7, 8. Twelve spacers 9, which form part of bottom plate 3, function to maintain a substantially constant spacing between plates 3, 4.

Inserted in each of the holes 6 in upper plate 4 is an insert member, in this case a forcing clamp 10, which will be discussed in more detail below.

Flower bulbs 11 can be placed into forcing rack 1 in various manners, for example by snapping upper plate 4 into frame 2 and placing the unit thus obtained upside down on a tilting table. After the desired number of flower bulbs 11 has been placed, bottom plate 3 can be snapped into frame 2, and after the tilting table has been tilted, forcing rack 1 is ready, for example for being stored in a cold room.

As already explained before, a forcing clamp 10 is disposed in each of the holes 6 in upper plate 4. Said forcing clamp 10, which is shown in more detail in FIG. 4, consists of an annular base 13, the outer diameter of which is adapted on the upper side to the diameter of the holes 6 in the upper plate 4. The outside diameter of bottom edge 14 of the annular base 13 is larger than the diameter of holes 6, so that this portion abuts against the bottom side of the aforesaid upper plate 4 and a precisely defined position of the forcing clamps 10 with respect to the upper plate 4 is ensured.

Forcing clamp 10 furthermore comprises eight flexible fingers 15, which seen in top view of forcing clamp 10 extend in radial direction and at an angle of for example approximately 30 degrees, seen in side view. Fingers 15 are spaced out evenly over the circumference of annular base 13. The length of fingers 15 is such that an opening 16 is left clear so as to allow the shoots 12 of the flower bulbs 10 to pass therethrough. In addition, each of the fingers 15 includes an upright portion 17, which provides a certain guidance for shoot 12 and the stem that grows therefrom.

By increasing the height of the bottom edge 14 of annular base 13 of at least some of the forcing clamps 10, for example to a height of 5-15 mm, said bottom edge 14 can function as a spacer. Spacers 9 can be left out in that case, whilst in addition a very stable construction of the forcing rack 1 is obtained, in particular if a large part of each of the forcing clamps 10 is provided with a high bottom edge 14. When such a construction is used, the frame 2 can be left out as well, and plates 3, 4 can be interconnected, for example by means of screws or bolts.

FIG. 5 shows a second embodiment of the forcing rack according to the invention, which is inter alia suitable for forcing irises, wherein the forcing clamps 10 are disposed in upside-down position in the holes 6. In this embodiment the planting of the flower bulbs 11 is greatly simplified, because the flower bulbs 11 can be placed into the forcing clamps 10 from above and be removed from said forcing clamps again in opposite direction.

The effective diameter of holes 6 in upper plate 4, in this case the inside diameter of annular base 13, is for example 45 mm. The forcing clamps 10 are preferably made from a flexible, plastic material, such as a polyolefin (PE, PP, etc.) or a polyamide, by means of an injection-moulding process. Such a plastic is preferably a so-called shape-memorising material.

FIGS. 6A and 6B show a part of a third forcing rack according to the invention wherein each of the holes 6 is provided with a support, such a cage or basket 18, for a bulb. The basket 18 comprises an annular floor 19 for supporting a bulb, which floor 19 has a hole 5 (for accommodating roots and the like) and is connected to an annular edge 20 by means of slightly divergent arms 21. The baskets 18 form an alternative to the bottom plate 3 and may either be fitted in the holes 6 or form integral whole with the upper plate 4. In the latter case, the upper plate 4 and the baskets 18 can be produced simultaneously using a single mould. Furthermore, this version can be cleaned more easily.

FIGS. 7A and 7B show a second forcing clamp 10 for use in a forcing rack according to the invention, especially the forcing rack according to FIGS. 6A and 6B. The clamp 10 again comprises an annular base 13 and eight flexible fingers 15. The fingers 15 comprise a concave portion 23, which forms the greater part of each of the fingers 15 and which improves their fatigue resistance, and further comprise a smaller convex portion 24 at or near their ends. The distance between the floor 19 of the basket 18 and the convex portions 24 is selected such that, upon placing a bulb, the convex portions 24 abut the same and preferably exert an substantially horizontal force on the circumference of the bulb at or below its largest diameter. A suitable configuration, which allows simple and secure insertion as well as easy removal of a 9 to 11 size bulb, is shown in FIG. 8 (scale 1:1). For 12 to 14 size bulbs, the dimensions of the clamp 10 and the basket 18 should be increased accordingly.

The forcing racks according to the invention can be placed into a so-called garden frame or flat, in which a layer of water is present. The garden frame preferably includes an overflow, which determines the level of the water in the garden frame. When legs or comparable spacers are disposed under the bottom plate of the forcing rack, whose length corresponds more or less to the distance between the overflow and the bottom of the garden frame, the root balls of the flower bulbs automatically come into contact with the water, whilst the bulbs themselves remain dry. In this manner the bulbs are prevented from developing rot.

Furthermore, the forcing racks are preferably fitted with handles, which are for example attached to or through the upper plate of the forcing rack.

Also other forms of the insert member are possible, of course, with an elastic membrane provided with a central opening being used, for example, instead of the aforesaid flexible fingers or teeth.

The invention is not restricted to the above-described embodiments as shown in the drawings, which can be varied in several ways without departing from the scope of the invention as defined in the claims. Thus it stands to reason that when the present invention is used for relatively large flower bulbs, such as lily bulbs, for example, the dimensions of the device can be adapted accordingly. Furthermore it is possible to add all kinds of elements to the forcing rack, such as one or more caps, for example, by means of which one or more of the planted bulbs can be forced in the dark.

1. A device (1) for forcing flower bulbs (11), which device (1) comprises at least one plate (4) or plate-like body provided with one or more holes (6), into which a flower bulb (11) can be placed, characterised in that the edge (10) of at least one of the holes (6), but preferably of all holes (6), is elastic and/or flexible to such an extent that a flower bulb (11) can be clampingly received therein.

2. A device (1) according to claim 1, wherein the edge (10) comprises a number of flexible elements, such as teeth or fingers (15), which, seen in top view, extend in radial direction.

3. A device (1) according to claim 1 or 2, wherein at least part of the edge, but preferably the entire edge, of said hole or said holes (6) is formed by a flexible insert member (10).

4. A device (1) according to claim 2 or 3, wherein the shape of said flexible elements (15) is adapted to the type of flower bulb (11) for which the device (1) is intended.

5. A device (1) according to any one of the claims 2-4, wherein the greater part (23) of the flexible elements (15) is concave.

6. A device (1) according to any one of the claims 2-5, wherein the flexible elements (15) comprise an angled or curved portion (24) the top of which, upon placing a bulb (11), abuts the same, preferably at or near the largest diameter of the bulb (11).

7. A device (1) according to any one of the preceding claims, wherein said flexible elements (15) are made from a shape-memorising material.

8. A device (1) according to any one of the preceding claims, wherein at least one of the holes (6), but preferably of all holes (6), is provided with a support (18) for a bulb (11), which support (18) is attached to or forms an integral whole with the plate (4) or plate-like body.

9. A device (1) according to any one of the claims 1-7, wherein a second plate (3) or plate-like body is provided, which second plate (3) or body is disposed under said first plate (4) or body, and which is provided with one or more holes (5) positioned under a respective hole (6) in said first plate (4) or body.

10. A device (1) according to any one of the preceding claims, wherein the holes (6) in said first plate (4) or body have an effective diameter of more than 42 mm.

11. An insert member (10) suitable for use in the device (1) according to any one of the preceding claims.

12. A method for forcing flower bulbs (11), wherein a device (1) according to any one of the preceding claims is used.
